(19) United States
(12) Patent Application Publication
(10) Pub. No.: US 2018/0001450 A1
(43) Pub. Date: Jan. 4, 2018

(54) FLUTED EXTRACTOR SYSTEM

(71) Applicants: WAYNE ANDERSON, NORTHPORT, NY (US); WARREN ANDERSON, NORTHPORT, NY (US)

(72) Inventors: WAYNE ANDERSON, NORTHPORT, NY (US); WARREN ANDERSON, NORTHPORT, NY (US)

(21) Appl. No.: 15/485,929

(22) Filed: Apr. 12, 2017

Related U.S. Application Data
(60) Provisional application No. 62/305,289, filed on Mar. 8, 2016.

(51) Int. Cl. B25B 27/18; B25B 21/00

(52) U.S. Cl. CPC B25B 27/18; B25B 21/002

(57) ABSTRACT

An extractor may include an elongated section including a proximal section configured to be coupled to a rotary tool and a distal section configured to be inserted into a bore of a bolt. A longitudinal axis may extend lengthwise through a center of the distal section and wherein the first and second surfaces are recessed inwardly toward the longitudinal axis. The distal section may be generally shaped as a prism having a generally polygonal cross-section including a plurality of faces, and a contact edge is defined between adjacent ones of the faces. Each of the faces includes a first surface and a second surface, the first surface narrowing in a direction toward a distal end of the distal section and the second surface widening in the direction toward the distal end of the distal section.

### CROSS REFERENCE TO RELATED APPLICATIONS

This application relates to and claims priority from U.S. Prov. Ser. No. 62/305,289 filed Mar. 8, 2016, the entire contents of which are incorporated herein by reference.

### FIGURE SELECTED FOR PUBLICATION

FIG. 7

### BACKGROUND OF THE INVENTION

### Technical Field

The present disclosure generally relates to a bolt extractor or threaded device extractor for use with screws or bolts; and more particularly to a bolt extractor tool for removing fasteners such as threaded fasteners such as bolt studs and having a particular geometric profile with improved resistance to fracture and breakage.

### Description of the Related Art

Extracting or dislodging a threaded member, here discussed as a bolt (e.g., a stud bolt or a threaded bolt or broken screw etc.) from a bore in which it has become bound due to corrosion, rust, thermal changes or the like can be difficult. Typically, removal of a broken bolt involves first using a drill bit to drill a hole into the center of the broken bolt, this is then removed, and an extractor is inserted and reversed until counter-threaded gripping portions are sufficiently engaged with the hole in the bolt such that continued rotation of the drill bit results in engaging the hole-sides and the bolt being unscrewed from the bore in which it is disposed.

Examples of conventional bolt extractors are shown and described with respect to FIGS. 1-5.

As shown in FIGS. 1-3, a bolt extractor 10 is shown relative to a threaded bolt B that is disposed within a threaded bore T. The bolt extractor 10 is generally cylindrical and includes a distal section 10d including gripping teeth 11 that are edges between adjacent ones of a plurality (e.g., five) arcuate or scalloped surfaces 12 of the distal section 10d. The gripping teeth 11 are configured to engage an opening within the bolt B. As considerable force is applied to the gripping teeth, the gripping teeth 11 may be stripped when the bolt extractor 10 is used. Grooves 11a indicate worn out regions of the gripping teeth 11. As can be appreciated in FIG. 3, the cross-section of the distal end of the bolt extractor 10 is approximately that of a pentagon and as such each of the angles between surfaces 12 is approximately 108° and the amount of pressure applied to the gripping teeth 11 is the same regardless of the direction of rotation. In other words, with the configuration of the bolt extractor 10, the same amount of force is exerted on the gripping teeth whether the bolt extractor 10 is rotated in a clockwise or in a counterclockwise direction during extraction of the bolt.

Other types of prior art bolt extractors are shown in FIGS. 4-6. A bolt extractor 20, as shown in FIG. 4, includes a distal section 20d that includes a pointed distal end 21, a plurality of arcuate or scalloped surfaces 22 and straight edges 23 between adjacent ones of the surfaces 22. As shown in FIG. 5, another bolt extractor 30 includes has a generally rectangular prism shape that includes a distal section 30d that includes grooves 33 that extend lengthwise along the distal section 30d at the edges of the rectangular or square shape of the prism. As shown in FIG. 6, a prior art bolt extractor 40 has a generally cylindrical shape including a distal section 40d having a helical or spiral groove forming a helical or spiral cutting edge.

There is a continuing need to provide bolt extractors that are more resilient and are less likely to break, fail, or otherwise become damaged during use.

### ASPECTS AND SUMMARY OF THE PRESENT INVENTION

Disclosed herein is a bolt extractor that may include an elongated section including a proximal section configured to be coupled to a rotary tool and a distal section configured to be inserted into a bore of a bolt. A longitudinal axis may extend lengthwise through a center of the distal section and wherein the first and second surfaces are recessed inwardly toward the longitudinal axis. The distal section is generally shaped as a specific prism having a generally polygonal cross-section including a plurality of faces, backing edge supports and an edge is defined between adjacent ones of the faces. Each of the faces includes a first surface and a second surface, with one supporting the other, the first surface narrowing in a direction toward a distal end of the distal section and the second surface widening in the direction toward the distal end of the distal section. The second surface may provide support to the edge defined between adjacent ones of the faces during counterclockwise rotation of the bolt extractor. In one preferred embodiment, a preferred polygonal cross-section may be that of a pseudo-pentagon or pseudo-five-sided, wherein each of the five-sides actually has two planes (as shown in in FIG. 9). The first and the second surfaces of each ‘side’ may define an obtuse angle (e.g., 170 to 180 degrees exclusive) therebetween, as shown, so that the backing material from the first side will assist the corresponding back of the other side.

The distal section may be configured to be inserted into a drilled out bore hole of a bolt such that rotation of the bolt extractor causes the bolt to correspondingly rotate. During use when rotating the bolt extractor counterclockwise, the force from the edges contacting the bore of the bolt is transferred toward the second surface and the corresponding backing profile, and proximally in a direction away from the distal section thereby counteracting the force and strengthening the edge, thereby decreasing a stress concentration at each of the edges. The first and second surfaces meet one another along a generally straight line. Each of the first and second surface may be generally flat and planar. Each of the generally straight lines between the first and second surfaces of each of the faces may be oriented along a substantially identical angle.

The bolt extractor may be formed from a high strength material that is resistant to heat and wear. Such a material may include, for example, polycrystalline diamond (PCD), tungsten carbide, cobalt steel, and/or high speed steel (HSS).

The above and other aspects, features and advantages of the present invention will become apparent from the following description read in conjunction with the accompanying drawings, in which like reference numerals designate the same elements.

### BRIEF DESCRIPTION OF THE DRAWINGS

FIG. 1 is a perspective view of a prior art bolt extractor shown relative to a threaded bolt;

FIG. 2 is a side view of a distal section of the bolt extractor of FIG. 1;

FIG. 3 is a view of the bolt extractor of FIG. 1 as seen from a distal end of the bolt extractor;

FIG. 4 is a perspective view of another prior art bolt extractor;

FIG. 5 is a perspective view of yet another prior art bolt extractor;

FIG. 6 is a perspective view of a further prior art bolt extractor;

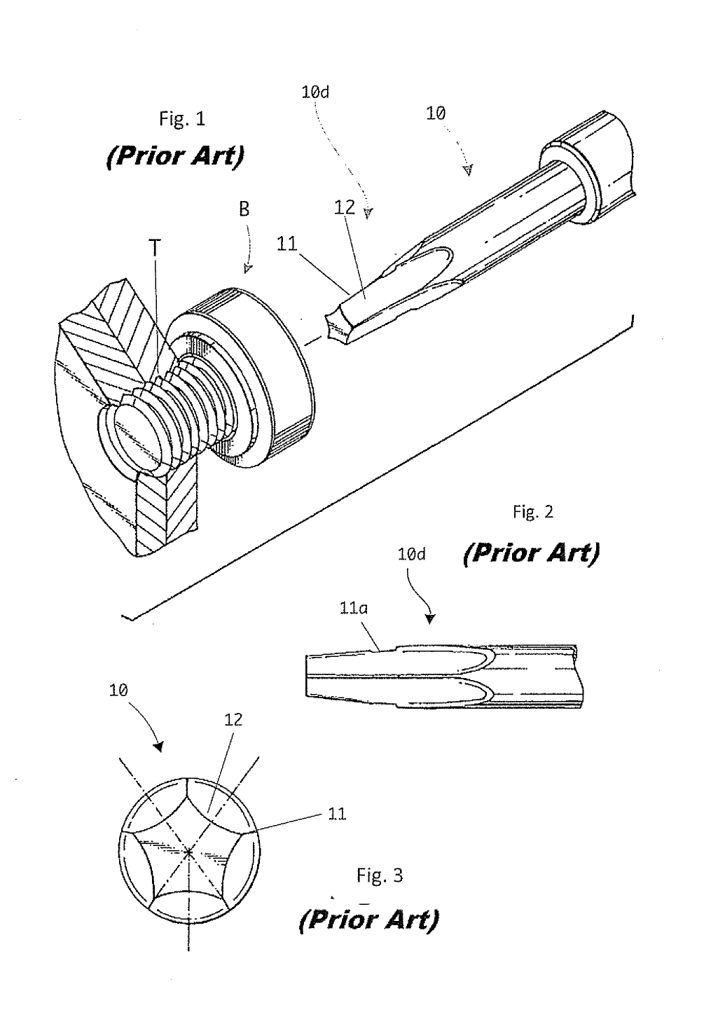

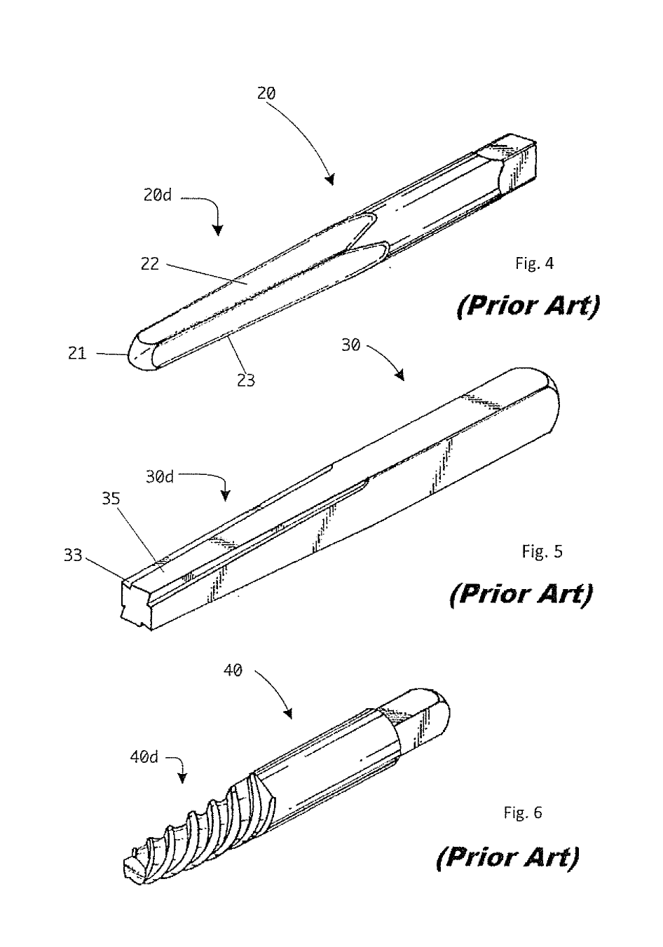

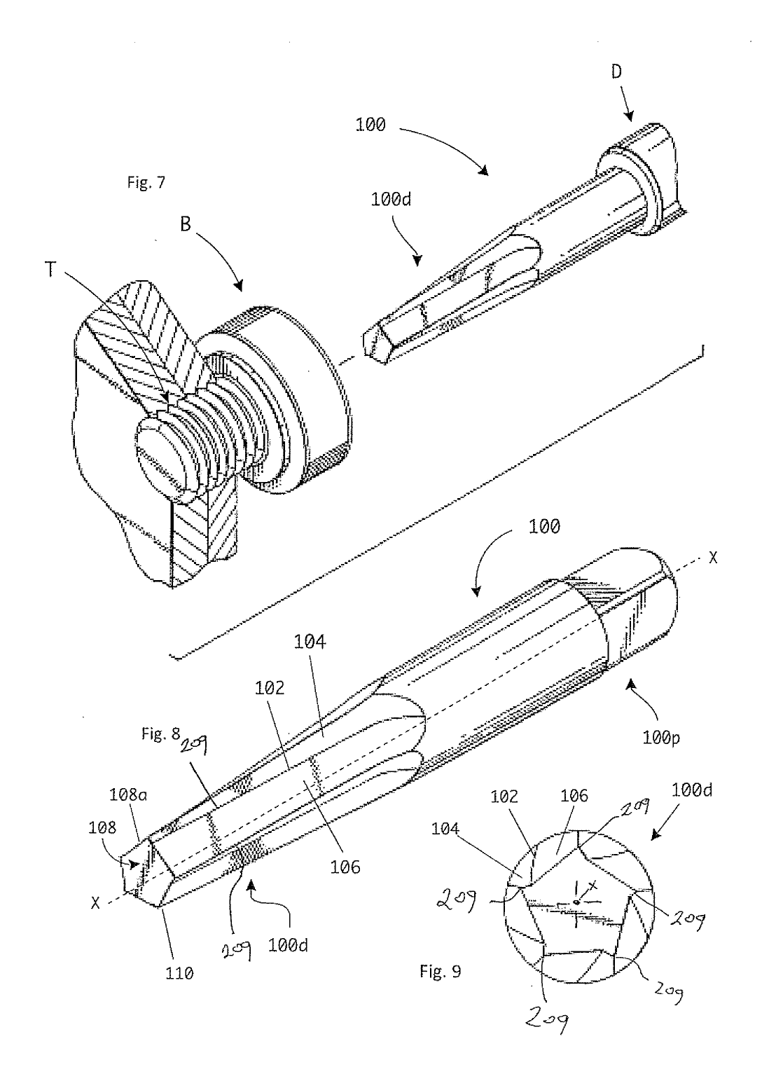

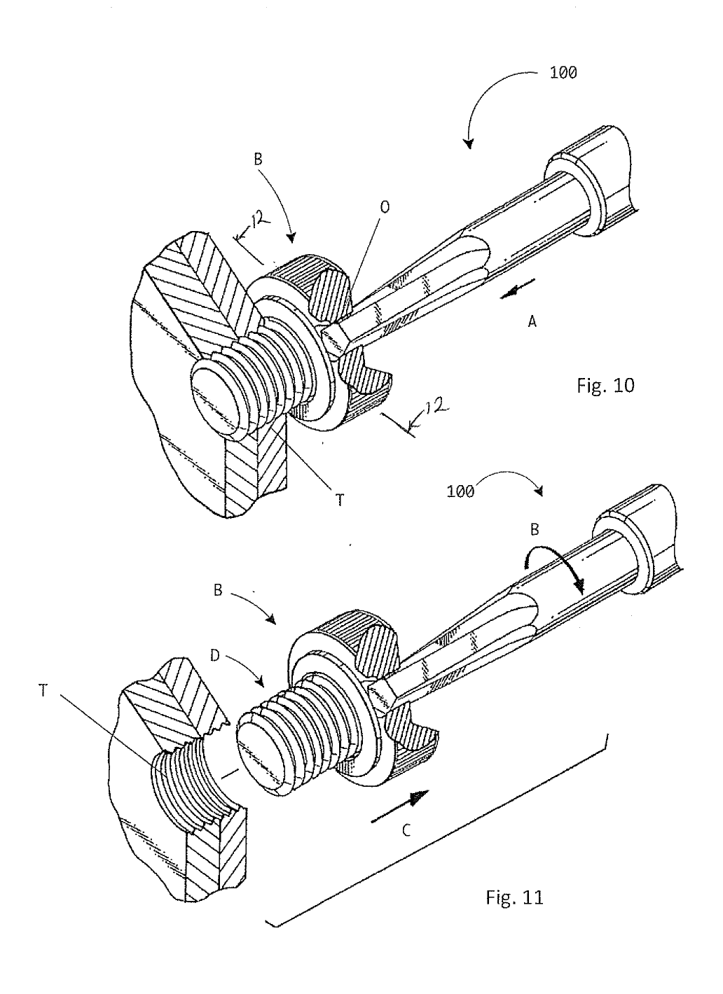

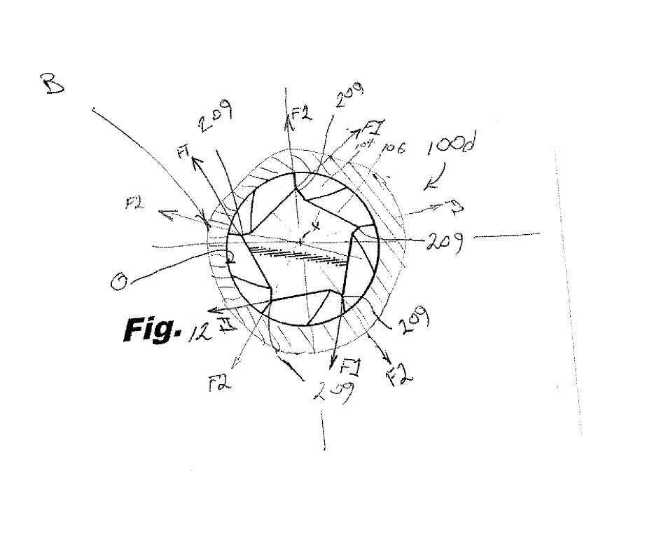

FIG. 7 is a perspective view of a bolt extractor in accordance with the present disclosure shown in relation to a bolt;

FIG. 8 is a perspective view of the bolt extractor of FIG. 7;

FIG. 9 is a view of the bolt extractor of FIG. 7 as seen from a distal end of the bolt extractor;

FIG. 10 is a perspective view of the bolt extractor of FIG. 7 shown inserted within a bore of the bolt of FIG. 7 with the bolt shown with a portion thereof removed;

FIG. 11 is a perspective view of the bolt extractor of FIG. 10 depicting removal of the bolt from within a threaded bore; and

FIG. 12 a partial cross-sectional end pictographic view along section 12-12 in FIG. 11, noting the contact surfaces and support forces in the present invention.

### DETAILED DESCRIPTION OF A PREFERRED EMBODIMENT

Reference will now be made in detail to embodiments of the invention. Wherever possible, same or similar reference numerals are used in the drawings and the description to refer to the same or like parts or steps. The drawings are in simplified form and are not to precise scale. The word ‘couple’ and similar terms do not necessarily denote direct and immediate connections, but also include connections through intermediate elements or devices. For purposes of convenience and clarity only, directional (up/down, etc.) or motional (forward/back, etc.) terms may be used with respect to the drawings. These and similar directional terms should not be construed to limit the scope in any manner. It will also be understood that other embodiments may be utilized without departing from the scope of the present invention, and that the detailed description is not to be taken in a limiting sense, and that elements may be differently positioned, or otherwise noted as in the appended claims without requirements of the written description being required thereto.

Referring to FIGS. 7-11, a bolt extractor 100 is now described. The bolt extractor includes a proximal section 100p and a distal section 100d. The proximal section may be configured to be operatively coupled to a tool, such as a rotary drill. The distal section 100d is configured to engage a bolt (e.g., a threaded bolt) that is stuck and has an extraction hole-drilled therein (or burned in depending on the material) that is disposed within a bore or hole T, which may be threaded.

The distal section 100d of the bolt extractor 100, as shown best in FIGS. 8 and 9, has a plurality of edges 102 extending orthogonally relative to rotation axis X-X extending lengthwise relative to the bolt extractor 100 such that a first surface 104 and a second surface 106 are formed on either side of the edge 102 along each of the 5 faces 108a of the pentagon shape 108. The first surface 104 and the second surface 106 may define an obtuse angle (e.g., within a range of 90 to 180 degrees exclusive or 170 to 180 degrees exclusive) therebetween which is extending from the distal end outwardly to the main diameter. Each of the surfaces 104, 106 taper inward or downward from an edge 110 corresponding to a point of the pentagon shape 108 toward the edge 102, thereby forming a recess or depression between adjacent ones of the edges 102. Each of the surfaces 104 and 106 may be generally planar or flat until reaching the outer diameter and they they are relieved in a curved cut, as shown. The first surface 104 is configured such that its width tapers or narrows from a proximal end thereof toward a distal end thereof, whereas the second surface 106 is configured such that its width widens from a proximal end thereof toward a distal end thereof. At the distal end of the bolt extractor 100, the second surface 106 provides a relatively large area as compared to the area provided by the first surface 104. As a result, when the bolt extractor is rotated in a counterclockwise direction B a relatively large amount of material provided by the second surface 106 is provided at the distal end of the bolt extractor 100, thereby supporting the edge 110 during rotation and minimizing the likelihood that the edge 110 fails or becomes damaged.

A method of operating the bolt extractor 100 is shown best in FIGS. 10 and 11 in which the bolt extractor 100 is inserted into an opening O of a proximal end of the bolt B. With the bolt extractor 100 engaged or sufficiently secured within the opening O of the bolt B by pressing the bolt extractor 100 into the opening O by forcing it into the open along directional arrow A, the bolt extractor 100 may then be rotated in the counterclockwise direction B such that rotation of the bolt extractor causes the bolt B to correspondingly rotate in a direction that causes the bolt B to rotate thereby causing the threads D of the bolt B to disengage from the threads of the bore T and the bolt B to move in a direction C out from the bore T.

The bolt extractor may be formed from a material that is heat and wear resistant including, for example, polycrystalline diamond (PCD), tungsten carbide, cobalt steel, and/or high-speed steel (HSS).

As will be understood by further considering FIGS. 9 and 12 in combination, an exemplary contact point 209 that contacts the side surfaces of a whole are shown in pictographic and force vector form along section 12-12 in FIG. 10. The contact points 209 are shown at a select location defined between the first and second surfaces 104,106 along each respective edge 102 and would be contacting the inner surfaces of the hole O. Necessarily, the outer dimension of the bolt-hole receiving the extractor and the depth of the bolt-hole confirms the location of contact points 209 relative to the overall extractor.

In any depth where contact points 209 contact the outer surfaces of hole O there is outer pressure exerted on the particular contact points 209 as shown in this pseudo-five-sided geometry, resulting in five-outer force vectors F1, F1, F1, F1, and F1. Each outer force vector does not pass through the center line X (noted above) and in FIG. 12. As a result, each force vector F1 does not counter-act an opposite-side force vector F (e.g., there is no countering other than by the strength of the edge back 102 and back surface 104 on each set). As a result, all removal rotational torque is extended outwardly to positively engage walls of the hole O, as shown. This is a surprising result of this geometry and prevents the shearing off and damage noted, for example in FIG. 2. As a further surprising result, during use the complete thickness (not just the contact edge) of the surface 104 backs the contact edge 102 along the force vector F1 and the particular contact point 209, which prevents damage of the contact point 209 and damage to the device.

In a related analysis, while a user drives the device inwardly (with a mallet or hammer) into hole O (before extraction rotation), contact points 209 along edge 102 directly make contact and provide an outwardly urging force perpendicular to the center axis X, shown as force vectors F2, F2, F2, F2, and F2. The counter force to these expansion forces F2, pass through the center axis X, but do not, in a preferred embodiment, counter an opposing outwardly urging force F2 (e.g., one F2 does not counter another F2 force). Indeed, the counter force to each F2 extends in a direction back through each corresponding surface 106. As a result, the maximum engagement force of driving is outwardly applied along each F2-directions so as to more firmly seat the device in hole O and prevent removal. Other most preferred embodiments utilize this process in odd-numbered side-geometries, e.g., 3, 5, 7, and 9. Other geometries with even-numbered sides 4, 6, 8, 10 lack this advantage, but retain the above driving force advantages from F1 vectors.

It will be understood, that any-side geometry according to the present concepts provides particular advantages over the prior inventions noted herein, are especially durable under maximum rotational force and are easily secured in any irregular hole O in a bolt.

In sum, the present invention provides surprising advantages from the inventive shapes, surfaces and arrangements herein.

Various operations may be described as multiple discrete operations in turn, in a manner that may be helpful in understanding embodiments of the present invention. However, the order of description should not be construed to imply that these operations are order dependent.

Having described at least one of the preferred embodiments of the present invention with reference to the accompanying drawings, it will be apparent to those skills that the invention is not limited to those precise embodiments, and that various modifications and variations can be made in the presently disclosed system without departing from the scope or spirit of the invention. Thus, it is intended that the present disclosure cover modifications and variations of this disclosure provided they come within the scope of the appended claims and their equivalents. It should be understood for example, that although the bolt extractor is described as being configured to be rotated counterclockwise to effect removal of a bolt, that such a rotation is conventional for removing threaded bolts and that should a bolt instead be configured to be rotated clockwise that one of ordinary skill in the art would appreciate that the bolt extractor may be configured in a manner to support such rotation of the bolt extractor.

What is claimed is:

1. A bolt extractor, comprising:
an elongated section including a proximal section configured to be coupled to a rotary tool and a distal section configured to be inserted into a bore of a bolt;
a longitudinal axis extends lengthwise through a center of the distal section and wherein the first and second surfaces are recessed inwardly toward the longitudinal axis from a distal end gradually outwardly to an outer dimension of said bolt extractor;
the distal section is shaped as a geometry prism having a generally polygonal cross-section including a plurality of faces, and a contact edge is defined between adjacent ones of the faces;
each of the faces includes a first surface and a second surface, the first surface narrowing in a direction toward a distal end of the distal section and the second surface widening in the direction toward the distal end of the distal section;
an angle between said first surface and said second surface being obtuse along an entire length of said contact edge.

2. The bolt extractor of claim 1, wherein:
the second surface provides support to the edge defined between adjacent ones of the faces during counterclockwise rotation of the bolt extractor.

3. The bolt extractor of claim 1, wherein:
the polygonal cross-section has five-sets of groups of said first surface and said second surface providing five contact edges.

4. The bolt extractor of claim 1, wherein the distal section is configured to be inserted into a bore of a bolt such that rotation of the bolt extractor causes the bolt to correspondingly rotate.

5. The bolt extractor of claim 4, wherein:
during use when rotating the bolt extractor counterclockwise, the force from the edges contacting the bore of the bolt is transferred toward the second surface and proximally in a direction away from the distal section thereby counteracting the force and strengthening the edge, thereby decreasing a stress concentration at each of the edges; and
said force from said edges contacting said bore does not pass through said longitudinal axis.

6. The bolt extractor of claim 1, wherein:
the first and second surfaces meet one another along a generally linear line generally extending along said longitudinal axis.

7. The bolt extractor of claim 1, wherein:
each of the first and second surfaces are generally flat and planar.

8. The bolt extractor of claim 6, wherein:
each of the generally straight lines between the first and second surfaces of each of the faces are oriented along a substantially identical angle about an outer dimension of said extractor.

9. The bolt extractor of claim 1, wherein:
the bolt extractor is formed from a high strength material that is resistant to heat and wear.

10. The bolt extractor of claim 1, wherein:
the material is selected from the group consisting of polycrystalline diamond (PCD), tungsten carbide, cobalt steel, and high speed steel (HSS).

11. The bolt extractor of claim 7, wherein:
the first and the second surfaces define an obtuse angle therebetween.

12. The bolt extractor of claim 11, wherein:
the obtuse angle is within a range of 170 to 180 degrees exclusive.
